(19) United States
(12) Patent Application Publication
(10) Pub. No.: US 2008/0005484 A1
(43) Pub. Date: Jan. 3, 2008

(54) Cache coherency controller management

(76) Inventor: Chandra P. Joshi, Bangalore (IN)

Correspondence Address: CAVEN & AGHEVLI;c/o INTELLEVATE, P.O. BOX 52050, MINNEAPOLIS, MN, 55402, US

(21) Appl. No.: 11/546,261

(22) Filed: Oct. 10, 2006

(30) Foreign Application Priority Data
Jun. 30, 2006 (IN) 1547/DEL/2006

(51) Int. Cl. G06F 13/28

(52) U.S. Cl. 711/141; 711/138

(57) ABSTRACT

Methods and apparatus to manage cache coherency are disclosed. In one embodiment, an apparatus comprises a first processor comprising a first processing unit, a first cache memory, and a first coherence controller, and an input/output module having one or more output ports. The first coherence controller comprises an arbitration logic module to direct a message into a processing pipeline and an output issue logic module. The output issue logic module analyzes a message in the processing pipeline, directs the message to an output queue when an output port is unavailable or when the message cannot bypass the output queue, and sends the message to the output port when one or more output ports are available or when the output queue can be bypassed.

### BACKGROUND

The present disclosure generally relates to the field of electronics. More particularly, an embodiment of the invention relates to cache coherency controller management.

Many processing devices include utilize cache memory to improve the performance of the processor, typically by reducing memory access latency. Processing devices that utilize multiple cache memory modules such as, e.g., multi-core processors, typically implement one or more techniques to maintain cache coherency. Cache coherency controllers have unpredictable output bandwidth requirements, which raise particular concerns in maintaining efficient operations of the controller managing cache coherency operations.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 is a schematic illustration of a microprocessor, according to an embodiment.

FIG. 2 is a schematic illustration of a cache controller, according to an embodiment.

FIG. 3 illustrates a flow diagram of a method to manage cache controller coherency, according to an embodiment.

FIGS. 4 and 5 illustrate block diagrams of embodiments of computing systems which may be utilized to implement various embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention.

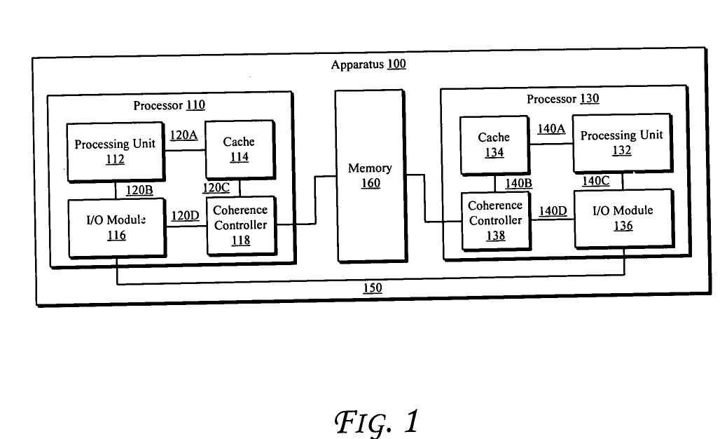

FIG. 1 is a schematic illustration of an electronic apparatus 100, according to an embodiment. Referring to FIG. 1, electronic apparatus 100 may comprise one or more processors 110, 130. Processor 110 may comprise a processing unit 112, a cache memory module 114, an input-output (I/O) module 116, and a coherence controller 118. Similarly, processor 130 may comprise a processing unit 132, a cache memory module 134, an input-output (I/O) module 136, and a coherence controller 138. In one embodiment, apparatus 100 may be a multi-core processor.

The various components of processors 110 may be coupled by one or more communication busses 120A, 120B, 120C, 120D, 120E which will be referred to collectively herein by reference numeral 120. The various components of processors 130 may be coupled by one or more communication busses 140A, 140B, 140C, 140D, 140E which will be referred to collectively herein by reference numeral 140. Further, processors 110, 130 may be coupled by a communication bus 150. Electronic apparatus 100 further comprises a memory module 160 coupled to processors 110, 130 by communication busses 120E, 140E. In one embodiment, the communication busses 120, 130, and 150 may be implemented as point-to-point busses.

The processors 110, 130 may be any processor such as a general purpose processor, a network processor that processes data communicated over a computer network, or other types of a processor including a reduced instruction set computer (RISC) processor or a complex instruction set computer (CISC). The processing units 112, 132 may be implemented as any type of central processing unit (CPU) such as, e.g., an arithmetic logic unit (ALU).

The memory module 160 may be any memory such as, e.g., Random Access Memory (RAM), Dynamic Random Access Memory (DRAM), Random Operational Memory (ROM), or combinations thereof. The I/O modules 116, 136 may include logic to manage one or more input/output ports on the respective communication busses 120, 130, 150 and the memory module 160.

In one embodiment, cache memory units 114, 134 may be embodied as write-back cache modules. The cache modules 114, 134 temporarily stores data values modified by the respective processors 110, 130, thereby reducing the number of bus transactions required to write data values back to memory module 160. In the embodiment depicted in FIG. 1 the cache modules 114, 134 are integrated within the respective processors 110, 130. In alternate embodiments, the cache modules 114, 134 may be external to the processors 110, 130, and coupled by a communication bus.

The coherence controllers 118, 138 manage operations to maintain cache coherency in cache modules 114, 118. For example, when processing unit 112 modifies a data value, the modified data value exists in its cache module 114 before it is written back to memory 160. Thus, until the data value in cache module 114 is written back to the memory module 160, the memory module 160 and other cache units (such as cache 134) will contain a stale data value.

Coherence controllers 118, 138 may implement one or more techniques to maintain cache coherency between cache modules 114, 138 and memory module 160. Cache coherency techniques typically utilize coherency status information which indicates whether a particular data value in a cache unit is invalid, modified, shared, exclusively owned, etc. While many cache coherency techniques exist, two popular versions include the MESI cache coherency protocol and the MOESI cache coherency protocol. The MESI acronym stands for the Modified, Exclusive, Shared and Invalid states while the MOESI acronym stands for the Modified, Owned, Exclusive, Shared and Invalid states.

The meanings of the states vary from one implementation to another. Broadly speaking, the modified state usually means that a particular cache unit has modified a particular data value. The exclusive state and owned state usually means that a particular cache unit may modify a copy of the data value. The shared state usually means that copies of a data value may exist in different cache units, while the invalid state means that the data value in a cache unit is invalid.

In one embodiment, cache controllers 118, 138 snoop bus operations and use the coherency status information to ensure cache coherency. For example, assume that a first processor having a first cache unit desires to obtain a particular data value. Furthermore, assume that a second processor having a second cache unit contains a modified version of the data value (the coherency status information indicates that the data value in the second cache unit is in the modified state).

In this example, the first processor initiates a read bus request to obtain the data value. The second cache unit snoops the read bus request and determines that it contains the modified version of the data value. The second cache unit then intervenes and delivers the modified data value to the first processor via the common bus. Depending on the system, the modified data value may or may not be simultaneously written to the main memory.

In another example, assume that the first processor desires to exclusively own a particular data value. Furthermore, assume that a second cache unit contains an unmodified, shared copy of the data value (the coherency status information indicates that the data value in the second cache unit is in the shared state). In this example, the first processor initiates a read bus request which requests data for exclusive use.

The second cache unit snoops the read bus request and determines that it contains a shared copy of the data value. The second cache unit then invalidates its shared data value by changing the data value's coherency status information to the invalid state. Changing the data value's coherency status to the invalid state invalidates the data value within the second cache unit. The first processor then completes the read bus request and obtains a copy of the data value from main memory for exclusive use.

In an alternate embodiment, cache controllers 118, 138 may implement a bus broadcasting technique to maintain cache coherency. For example, in multiple-bus systems bus transactions initiated on each bus may broadcast to other buses in the system.

In an alternate embodiment, cache controllers 118, 138 may implement directory-based cache coherency methods. In directory techniques, the main memory subsystem maintains memory coherency by storing extra information with the data. The extra information in the main memory subsystem may indicate 1) which processor or processors have obtained a copy of a data value and 2) the coherency status of the data values. For example, the extra information may indicate that more than one processor shares the same data value. In yet another example, the extra information may indicate that only a single processor has the right to modify a particular data value.

When a processor requests a data value, the main memory subsystem determines whether it has an up-to-date version of the data value. If not, the main memory subsystem transfers the up-to-date data value from the processor with the up-to-date data value to the requesting processor. Alternatively, the main memory can indicate to the requesting processor which other processor has the up-to-date data value.

In an alternate embodiment, cache controllers 118, 138 may implement a bus interconnect cache coherency technique in which coherency status information associated with the data values which are stored in the respective cache units 114, 134. The particular cache coherency technique(s) implemented by the coherence controllers 118, 138 are beyond the scope of this disclosure.

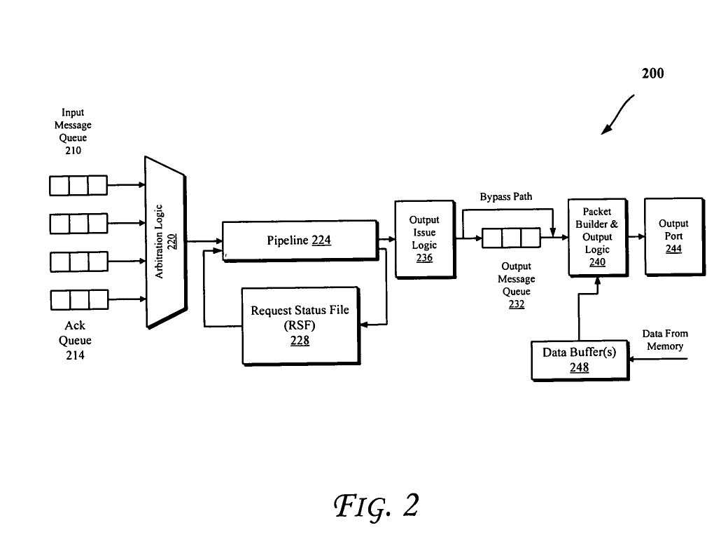

In one embodiment, coherence controllers 118, 138 may be implemented as logical units such as, e.g., software or firmware executable on processors 110, 130. In alternate embodiments, coherence controllers may be implemented as logic circuitry on processors 110, 130. FIG. 2 is a schematic illustration of a coherence controller 200 such as coherence controllers 118, 138, according to an embodiment.

Referring to FIG. 2, coherence controller 200 receives one or more input message queues 210. For example, input queues 210 may include request queues, snoop response queues, memory controller response queues, and intermediate arbitration queues. Coherence controller 200 may also receive an acknowledgment (ACK) queue 214.

Input message queues may be directed to arbitration logic module 220, which arbitrates for access to processing pipeline 224. In one embodiment, pipeline 224 may be implemented as a multi-stage processing pipeline. Pipeline 224 may generate messages of variable bandwidth requirements, which may be sent to various destinations through an output port 244. The bandwidth requirement of these outgoing messages generally is not known when arbitration logic module 220 issues a messages from input side queues into pipeline 224.

In one embodiment, processing pipeline 224 maintains a request status file 228 that tracks the status of requests to coherence controller 200. Request status file 228 may track various stages of a request such as, for example, whether requests, responses, memory acknowledgments and the like are received, internal states etc. Request status file 228 may record a request identifier associated with each request and store a status identifier associated with the request identifier. In one embodiment, the status identifier may identify the request as pending, in-process, in the output queue, or transmitted to an output port.

Coherence controller 200 further includes an output issue logic module 236, which operates on the messages in the pipeline 224 to manage the release of messages from processing pipeline 224. Messages released from the output queue 232 are directed to a packet builder and output logic module 240, which places the output message into one or more data packets and outputs the data packet to an output port 244 for transmission across a data bus. In some embodiments, packet builder and output logic module 240 and output port 244 may be a component of an I/O module such as I/O modules 116, 136, rather than a component of a coherence controller 200.

Coherence controller 200 may further include one or more data buffers 248 that receive data from memory such as, e.g., memory module 160. For example, data buffer 248 may receive data from memory module 160, resulting from a read operation or a write data to be written to memory module 160.

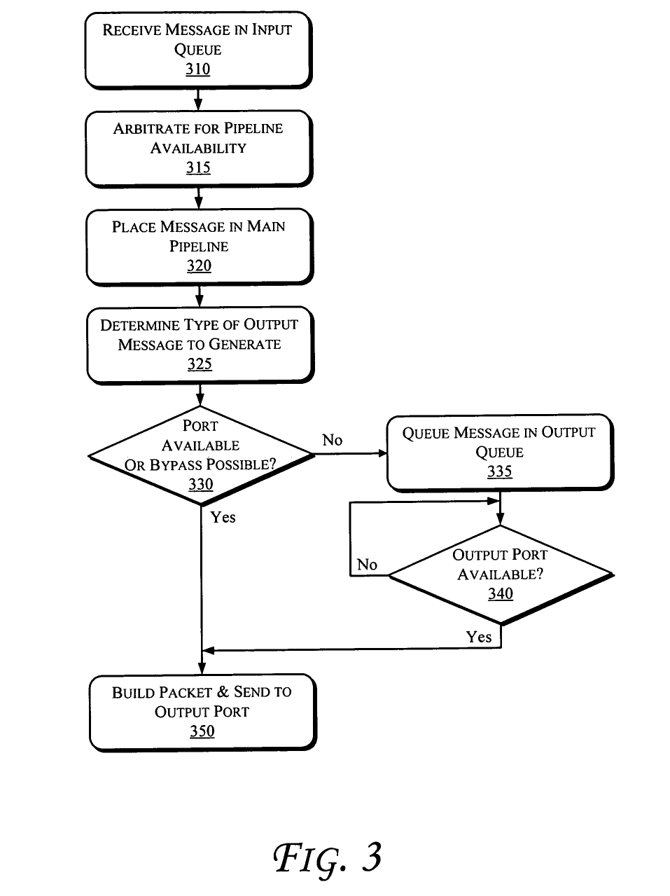

FIG. 3 illustrates a flow diagram of a method to manage cache controller coherency, according to an embodiment, and will be described with reference to the cache controller 200 illustrated in FIG. 2. The operations illustrated in FIG. 3 may be implemented as logic instructions recorded in a machine-readable memory, e.g., as software executable on a processor such as processor 112 or as firmware executable by a controller such as, e.g., an I/O port controller. Alternatively, the operations of FIG. 3 may be reduced to logic in a configurable logic device such as, e.g., a Field Programmable Gate Array (FPGA), or hard-wired in a logic device such as, e.g., an application specific integrated circuit (ASIC) or as a component of an I/O controller on an integrated circuit, such as processors 110, 130. In one embodiment, operations 310-320 may be implemented by the arbitration logic module 220 depicted in FIG. 2, operations and operations 325-340 may be implemented by output issue logic module 236 depicted in FIG. 2, and operation 350 may be implemented by the packet builder and output logic module 240 depicted in FIG. 2.

Referring to FIG. 3, at operation 310 an input message is received into an input queue. In one embodiment, the input queue may be one or more of the input queues described above with reference to FIG. 2. At operation 315 the arbitration logic module 220 arbitrates for pipeline availability for the received message(s). In one embodiment, the arbitration logic module selects a message from the input queues to be processed without regard to the availability of output ports. At operation 320 a selected message is placed in the processing pipeline 224.

At operation 325 the type of output message to be generated is determined. For example, based on type of request or snoop response received in the input message queue 210 and memory ack queue 214, a message may be sent to a caching agent. When message is issued from arbitration logic 220, it is not aware of the type of original request and or the current status. For example, when only a message for a read request has been is received, no output message is generated. Similarly, when a snoop response is received and it is not last then no output message is generated. Similarly, if all responses are received but no memory ack is received then no output message is generated. By contrast, if all these operations are done then it will send a data message that may keep output port busy for some time.

If, at operation 330, an output port is available or if a bypass is possible (for example, if the output message queue 232 is empty or if the output message is given priority over messages in the output message queue 232), then control passes to operation 350 and the packet builder and output logic module 240 constructs a packet and sends the packet to an output port 244.

By contrast, if at operation 330 a port is not available (and the output port cannot be bypassed) then control passes to operation 335 and the message is queued in the output message queue 232. At operation 340 the output issue logic module 236 waits for an output port to become available, whereupon control passes to operation 350 and the packet builder and output logic module 240 constructs a packet and sends the packet to an output port 244. In some embodiments the output issue logic module 236 may compare a bandwidth requirement associated with the message to an amount of bandwidth available on the output port to determine whether an output port is available.

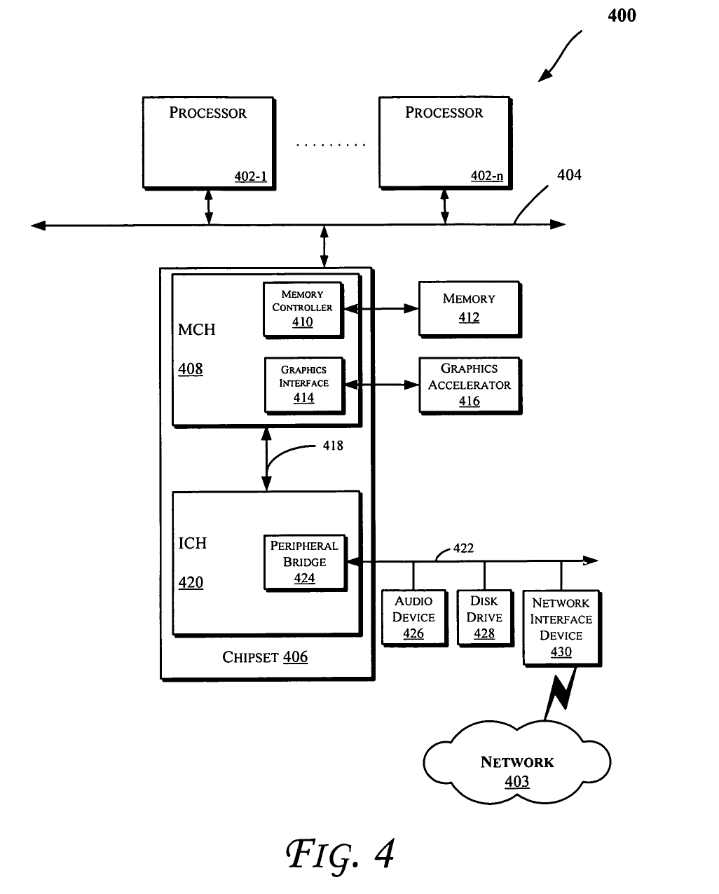

In embodiments, the system of FIGS. 2-3 may be implemented within a computing system. FIG. 4 illustrates a block diagram of a computing system 400 in accordance with an embodiment of the invention. The computing system 400 may include one or more central processing unit(s) (CPUs) 402 or processors in communication with an interconnection network (or bus) 404. The processors 402 may be any processor such as a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors.

A chipset 406 may also be in communication with the interconnection network 404. The chipset 406 may include a memory control hub (MCH) 408. The MCH 408 may include a memory controller 410 that communicates with a memory 412. The memory 412 may store data and sequences of instructions that are executed by the CPU 402, or any other device included in the computing system 400. In one embodiment of the invention, the memory 412 may include one or more volatile storage (or memory) devices such as random access memory (RAM), dynamic RAM (DRAM), synchronous DRAM (SDRAM), static RAM (SRAM), or other types of memory. Nonvolatile memory may also be utilized such as a hard disk. Additional devices may communicate through the interconnection network 404, such as multiple CPUs and/or multiple system memories.

The MCH 408 may also include a graphics interface 414 that communicates with a graphics accelerator 416. In one embodiment of the invention, the graphics interface 414 may be in communication with the graphics accelerator 416 via an accelerated graphics port (AGP). In an embodiment of the invention, a display (such as a flat panel display) may communicate with the graphics interface 414 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 418 may allow the MCH 408 to communicate with an input/output control hub (ICH) 420. The ICH 420 may provide an interface to I/O devices that communicate with the computing system 400. The ICH 420 may communicate with a bus 422 through a peripheral bridge (or controller) 424, such as a peripheral component interconnect (PCI) bridge, a universal serial bus (USB) controller, or other types of a bus. The bridge 424 may provide a data path between the CPU 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other types of peripherals.

The bus 422 may communicate with an audio device 426, one or more disk drive(s) 428, and a network interface device 430 (which may be in communication with the computer network 403). Other devices may communicate through the bus 422. Also, various components (such as the network interface device 430) may be in communication with the MCH 408 in some embodiments of the invention. In addition, the processor 402 and the MCH 408 may be combined to form a single chip. Furthermore, the graphics accelerator 416 may be included within the MCH 408 in other embodiments of the invention.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media capable of storing electronic instructions and/or data.

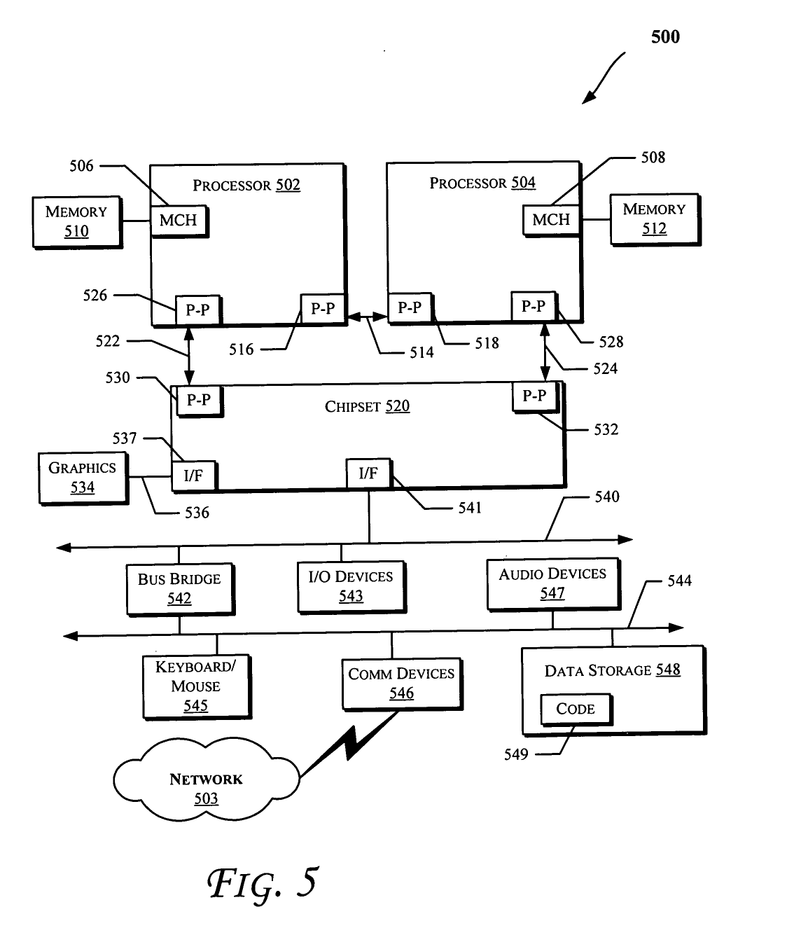

FIG. 5 illustrates a computing system 500 that is arranged in a point-to-point (PtP) configuration, according to an embodiment of the invention. In particular, FIG. 5 shows a system where processors, memory, and input/output devices are interconnected by a number of point-to-point interfaces. The operations discussed with reference to FIG. 3 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to communicate with memories 510 and 512. The memories 510 and/or 512 may store various data such as those discussed with reference to the memory 612.

The processors 502 and 504 may be any type of a processor such as those discussed with reference to the processors 402 of FIG. 4. The processors 502 and 504 may exchange data via a point-to-point (PtP) interface 514 using PtP interface circuits 516 and 518, respectively. The processors 502 and 504 may each exchange data with a chipset 520 via individual PtP interfaces 522 and 524 using point to point interface circuits 526, 528, 530, and 532. The chipset 520 may also exchange data with a high-performance graphics circuit 534 via a high-performance graphics interface 536, using a PtP interface circuit 537.

At least one embodiment of the invention may be provided within the processors 502 and 504. Other embodiments of the invention, however, may exist in other circuits, logic units, or devices within the system 500 of FIG. 5. Furthermore, other embodiments of the invention may be distributed throughout several circuits, logic units, or devices illustrated in FIG. 5.

The chipset 520 may be in communication with a bus 540 using a PtP interface circuit 541. The bus 540 may have one or more devices that communicate with it, such as a bus bridge 542 and I/O devices 543. Via a bus 544, the bus bridge 543 may be in communication with other devices such as a keyboard/mouse 545, communication devices 546 (such as modems, network interface devices, or other types of communication devices that may be communicate through the computer network 603), audio I/O device, and/or a data storage device 548. The data storage device 548 may store code 549 that may be executed by the processors 502 and/or 504.

In various embodiments of the invention, the operations discussed herein, e.g., with reference to FIGS. 2 and 3, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include any type of a storage device such as those discussed with respect to FIGS. 4 and 5.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method, comprising:
receiving a message in a cache controller;
directing the message into a processing pipeline in the cache controller;
analyzing the message in the processing pipeline in an output issue logic module;
directing the message to an output queue when an output port is unavailable or when the message cannot bypass the output queue; and
sending the message to the output port when the output port is available or when the output queue can be bypassed.

2. The method of claim 1, further comprising sending the message from the output queue to the output port when the output port is available.

3. The method of claim 1, wherein receiving a message in an input port of a cache controller comprises receiving at least one of a request message, a snoop response message, a memory controller response request, and an intermediate arbitration message.

4. The method of claim 1, wherein directing the message to an output queue when an output port is unavailable comprises comparing a bandwidth requirement associated with the message to an amount of bandwidth available on the output port.

5. The method of claim 4, further comprising constructing a packet for the message and outputting the packet from the output port.

6. The method of claim 5, further comprising updating a transaction entry associated with the message in a request status file.

7. An apparatus comprising:
a first processor comprising a first processing unit, a first cache memory, and a first coherence controller, and an input/output module having one or more output ports, the first coherence controller comprising:
an arbitration logic module to direct a message into a processing pipeline; and
an output issue logic module to:
analyze a message in the processing pipeline;
direct the message to an output queue when an output port is unavailable or when the message cannot bypass the output queue; and
send the message to the output port when one or more output ports are available or when the output queue can be bypassed.

8. The apparatus of claim 7, wherein the arbitration logic module directs the message into the processing pipeline without regard to output port availability.

9. The apparatus of claim 7, wherein the message exits from the output queue to when the output port is available.

10. The apparatus of claim 7, wherein the output issue logic module compares a bandwidth requirement associated with the message to an amount of bandwidth available on the output port.

11. The apparatus of claim 7, further comprising a packet builder and output logic module to construct a packet for the message and output the packet from the output port.

12. The apparatus of claim 7, further comprising a request status file that maintains a status indicator associated with the message.

13. The apparatus of claim 7, further comprising:
a second processor comprising a second processing unit, a second cache memory, and a second coherence controller, and an input/output module having one or more output ports; and
a communication bus coupled to the first processor and the second processor.

14. The apparatus of claim 13, wherein the second coherence controller comprises:
an arbitration logic module to direct a message into a processing pipeline; and
an output issue logic module to:
analyze a message in the processing pipeline;
direct the message to an output queue when an output port is unavailable or when the message cannot bypass the output queue; and
send the message to the output port when one or more output ports are available or when the output queue can be bypassed.

15. A system, comprising:
a memory module;
a first processor comprising a first processing unit, a first cache memory, and a first coherence controller, and an input/output module having one or more output ports, the first coherence controller comprising:
an arbitration logic module to direct a message into a processing pipeline; and
an output issue logic module to:
analyze a message from the processing pipeline in an output logic module;
direct the message to an output queue when an output port is unavailable or when the message cannot bypass the output queue; and
send the message to the output port when one or more output ports are available or when the output queue can be bypassed.

16. The system of claim 15, wherein the arbitration logic module directs the message into the processing pipeline without regard to output port availability.

17. The system of claim 15, wherein the output issue logic module sends the message from the output queue to the output port when the output port is available.

18. The system of claim 15, wherein the output issue logic module compares a bandwidth requirement associated with the message to an amount of bandwidth available on the output port.

19. The system of claim 15, further comprising a packet builder and output logic module to constructing a packet for the message and output the packet from the output port.

20. The system of claim 15, further comprising a request status file that maintains a status indicator associated with the message.

21. The system of claim 15, further comprising:
a second processor comprising a second processing unit, a second cache memory, and a second coherence controller, and an input/output module having one or more output ports; and
a communication bus coupled to the first processor and the second processor.

22. The system of claim 21, wherein the second coherence controller comprises:
an arbitration logic module to direct an input message into a processing pipeline; and
an output issue logic module to:
analyze a message from the processing pipeline in an output logic module;
direct the message to an output queue when an output port is unavailable or when the message cannot bypass the output queue; and
send the message to the output port when one or more output ports are available or when the output queue can be bypassed.
